(19) United States
(12) Patent Application Publication
(10) Pub. No.: US 2025/0071501 A1
(43) Pub. Date: Feb. 27, 2025

(54) AUDIO DEVICE AND WORKING METHOD THEREOF, VR DEVICE

(71) Applicant: BOE TECHNOLOGY GROUP CO., LTD., Beijing (CN)

(72) Inventors: Yapeng Li, Beijing (CN); Yangbing Li, Beijing (CN); Fangyuan Zhao, Beijing (CN); Yaqian Ji, Beijing (CN); Hao Zhang, Beijing (CN)

(73) Assignee: BOE TECHNOLOGY GROUP CO., LTD., Beijing (CN)

(21) Appl. No.: 18/771,206

(22) Filed: Jul. 12, 2024

Related U.S. Application Data
(63) Continuation of application No. PCT/CN2023/114658, filed on Aug. 24, 2023.

(51) Int. Cl. H04S 7/00

(52) U.S. Cl. CPC H04S 7/304; H04S 2400/11; H04S 2420/01

(57) ABSTRACT

An audio device and working method thereof, and a VR device are provided, and pertain to the field of space audio technologies. The audio device includes: a sound chamber; at least one speaker located within the sound chamber; an acquisition unit, configured to respectively obtain audio data and a target ear spectral curve HRTF at a position of a virtual sound source corresponding to the audio data; a computing unit, configured to process the audio data based on the target HRTF, generate a target sound signal, and output the target sound signal to the speaker. The technical solutions of the present disclosure can simulate three-dimensional sound production in space and create a sense of spatial immersion.

### CROSS-REFERENCE TO RELATED APPLICATIONS

This application is a continuation application of International Application No. PCT/CN2023/114658 filed on Aug. 24, 2023, which is incorporated herein by reference in its entirety.

### TECHNICAL FIELD

The present disclosure relates to the field of space audio technologies, in particular to an audio device and working method thereof, and a VR device.

### BACKGROUND

When users use VR (Virtual Reality, virtual reality) and/or AR (Augmented Reality, augmented reality) devices to watch movies or play games, display devices of VR and/or AR devices can provide users with an immersive feeling. However, the existing audio devices of VR and/or AR devices can only support dual channel surround sound, resulting in weak sense of presence and cannot meet the requirements of immersive 3D sound field experience for users.

### SUMMARY

The technical problem to be solved by the present disclosure is to provide an audio device and working method thereof, and a VR device, capable of simulating three-dimensional sound production in space and creating a sense of spatial immersion.

To solve the aforementioned technical problem, embodiments of the present disclosure provide the following technical solutions:

According to a first aspect, providing an audio device including:
a sound chamber;
at least one speaker located within the sound chamber;
an acquisition unit, configured to respectively obtain audio data and a target ear spectral curve HRTF at a position of a virtual sound source corresponding to the audio data;
a computing unit, configured to process the audio data based on the target HRTF, generate a target sound signal, and output the target sound signal to the speaker.

In some embodiments, the audio device is a neck hanging audio device, the sound chamber is located within the neck hanging portion of the neck hanging audio device.

In some embodiments, the audio device further includes:
a power supply located within the neck hanging portion;
the speaker is connected to the power supply through wired means.

In some embodiments, the audio device further includes:
at least one low-frequency passive diaphragm and/or audio waveguide tube located within the sound chamber.

In some embodiments, the low-frequency passive diaphragm and the speaker are set at intervals; and/or,
the audio waveguide tube and the speaker are set at intervals.

In some embodiments, the audio device is applied to a VR device, and the audio device further includes:
a positioning unit, configured to locate a relative position relationship between the speaker and a target part, the target part includes head and/or ears;
the computing unit is specifically configured to obtain a first position of a virtual audio source in a space coordinate system of the VR device; obtain a second position of the target part in the space coordinate system, and determine a third position of the speaker in the space coordinate system based on the relative position relationship between the speaker and the target part; generate the target sound signal based on the target HRTF at the first position, the HRTF at the third position, and the audio data.

In some embodiments, the positioning unit includes at least one of the following:
a transmitting and receiving unit, including a transmitting unit located on a head-mounted display of the VR device and a receiving unit located on the neck hanging portion, the transmitting unit is configured to transmit a target signal, and the receiving unit is configured to determine a relative position relationship between the head-mounted display and the speaker based on the received signal, and determine the relative position relationship between the speaker and the target part based on the relative position relationship between the head-mounted display and the speaker, the target signal includes at least one of the following: non-sinusoidal narrow pulse, ultrasound, optical signal, or electromagnetic wave;
an image processing unit set at the neck hanging portion, configured to obtain an image of the target part and determine the relative position relationship between the speaker and the target part based on the image;
an inertial sensor IMU set at the neck hanging portion, configured to record relative rotation and displacement between the head-mounted display of the VR device and the neck hanging portion, determine the relative position between the head-mounted display and the speaker based on the recorded relative rotation and displacement, and determine the relative position relationship between the speaker and the target part based on the relative position between the head-mounted display and the speaker.

In some embodiments, the audio device further includes:
an external interface, configured to connect to wired earphones.

In some embodiments, the audio device further includes:
a microphone set at the neck hanging portion.

The embodiments of the present disclosure further provide a VR device, including a head-mounted display and an aforementioned audio device.

The embodiments of the present disclosure further provide a working method of audio device applied to the aforementioned audio device, where the working method includes:
respectively obtaining audio data and a target ear spectral curve HRTF at a position of a virtual sound source corresponding to the audio data;
processing the audio data based on the target HRTF, generating a target sound signal, and outputting the target sound signal to the speaker.

In some embodiments, the sound signal includes a right channel signal and a left channel signal, before outputting the target sound signal to the speaker, the method further includes:
eliminating a crosstalk signal generated by the right channel signal from the left channel signal, and eliminating a crosstalk signal generated by the left channel signal from the right channel signal.

In some embodiments, the working method further includes:
locating a relative position relationship between the speaker and a target part, the target part includes head and/or ears;
the processing the audio data based on the target HRTF and generating a target sound signal includes:
obtaining a first position of a virtual audio source in a space coordinate system of the VR device; obtaining a second position of the target part in the space coordinate system, and determining a third position of the speaker in the space coordinate system based on the relative position relationship between the speaker and the target part; generating the target sound signal based on the target HRTF at the first position, the HRTF at the third position, and the audio data.

In some embodiments, the locating a relative position relationship between the speaker and a target part includes at least one of the following:
using a transmitting unit to transmit a target signal, using a the receiving unit to determine the relative position relationship between the head-mounted display and the speaker based on the received signal, and determining the relative position relationship between the speaker and the target part based on the relative position between the head-mounted display and the speaker, the target signal includes at least one of the following: non-sinusoidal narrow pulse, ultrasound, optical signal, or electromagnetic wave;
using the image processing unit to obtain an image of the target part, and determining the relative position relationship between the speaker and the target part based on the image;
using the inertial sensor IMU to record relative rotation and displacement between the head-mounted display of the VR device and the neck hanging portion, determining the relative position between the head-mounted display and the speaker based on the recorded relative rotation and displacement, and determining the relative position relationship between the speaker and the target part based on the relative position between the head-mounted display and the speaker.

The beneficial effects of the embodiments of the present disclosure are as follows.

In the above solutions, obtain the target HRTF at the position of the virtual sound source corresponding to the audio data, process the audio data based on the target HRTF, generate the target sound signal, and control the speaker to produce sound based on the target sound signal, which can achieve simulated three-dimensional sound production in space and create a sense of spatial immersion.

### BRIEF DESCRIPTION OF THE DRAWINGS

FIG. 1 to FIG. 4 are structural schematic diagrams of audio devices according to some embodiments of the present disclosure;

FIG. 5 to FIG. 6 are schematic diagrams of the audio device applied to a VR device according to the embodiments of the present disclosure;

FIG. 7 is a structural schematic diagram of an audio device according to another embodiment of the present disclosure;

FIG. 8 to FIG. 9 are flow diagrams of a working method of audio device according to the embodiments of the present disclosure.

### REFERENCE NUMERALS

01 audio device
02 head-mounted display
03 virtual audio source
011 sound chamber
012 speaker
013 low-frequency passive diaphragm
014 audio waveguide tube
015 microphone
016 wired earphones

### DETAILED DESCRIPTION

In order to make the technical problem, the technical solutions and the advantages of the embodiments of the present disclosure more apparent, the present disclosure will be described hereinafter in conjunction with the drawings and embodiments.

The embodiments of the present disclosure provide an audio device and working method thereof, and a VR device, capable of simulating three-dimensional sound production in space and creating a sense of spatial immersion.

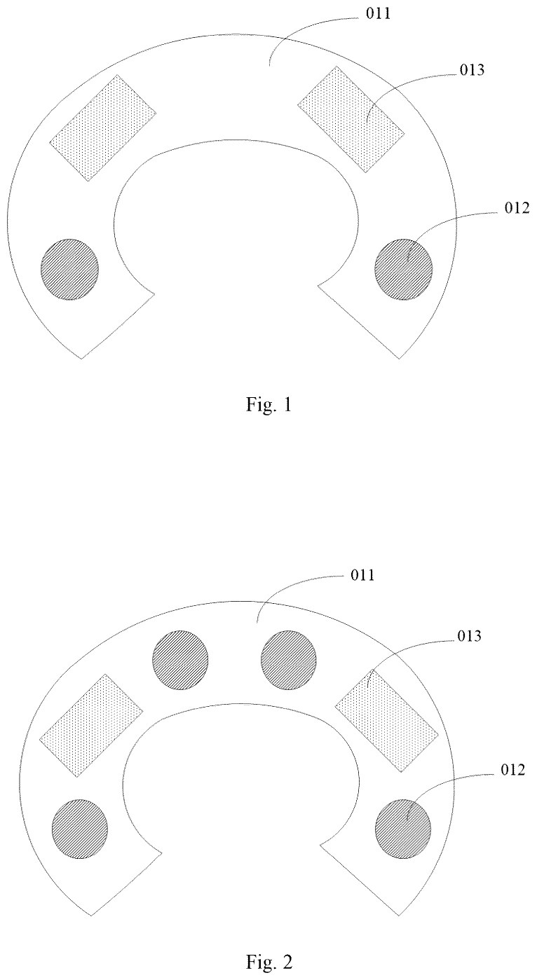

The embodiments of the present disclosure provide an audio device, as shown in FIG. 1 to FIG. 4, including:
a sound chamber 011;
at least one speaker 012 located within the sound chamber 011;
an acquisition unit, configured to respectively obtain audio data and a target ear spectral curve HRTF at a position of a virtual sound source corresponding to the audio data;
a computing unit, configured to process the audio data based on the target HRTF, generate a target sound signal, and output the target sound signal to the speaker 012.

In the embodiments, obtain the target HRTF at the position of the virtual sound source corresponding to the audio data, process the audio data based on the target HRTF, generate the target sound signal, and control the speaker to produce sound based on the target sound signal, which can achieve simulated three-dimensional sound production in space and create a sense of spatial immersion.

HRTF (Head Related Transfer Function) is an abbreviation for Head Related Transfer Function, also known as Ear Spectral Curve. HRTF is a mathematical function configured to measure and evaluate the transmission of sound in the human ear. It can measure spatial characteristics generated when sound is transmitted through the human eardrum, and can simulate three-dimensional sound production in space through HRTF.

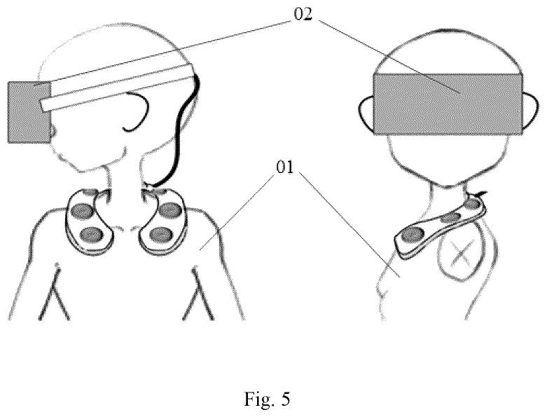

In related art, whether it is an in-ear headphone or a headset, long-term wear can easily affect the user's listening ability. Wearing an in-ear headphone too frequently can easily lead to problems such as ear canal inflammation, while wearing a headset can easily cause stuffiness and sweating. In the embodiments, the audio device can be a neck hanging audio device, as shown in FIG. 5. The audio device 01 can be worn on the user's neck, which can avoid the harm of in-ear headphones or headsets.

As shown in FIG. 1 to FIG. 4, in the case that the audio device 01 is a neck hanging audio device, the sound chamber 011 can be located within the neck hanging portion of the neck hanging audio device, so that the audio device 01 can produce sound around the user's head, providing a good auditory experience for the user. One or more speakers 012 can be installed inside the sound chamber 011. In the case that multiple speakers 012 are installed inside the sound chamber 011, they are evenly distributed within the sound chamber 011. In the embodiments, in order to improve the privacy of the audio device, the speaker 012 can be selected as a speaker with a small radiation angle.

In some embodiments, the audio device further includes: a power supply located within the neck hanging portion, which can integrate the power supply into the neck hanging portion, simplifying the structure of the audio device. In the case that the power supply is located within the neck hanging portion, the speaker 012 can be connected to the power supply through wired means.

In some embodiments, as shown in FIG. 1 and FIG. 2, the audio device further includes at least one low-frequency passive diaphragm 013 located within the sound chamber 011, which can improve the low-frequency effect of the audio device. In the embodiments, the speaker 012 and the low-frequency passive diaphragm 013 can be matched in different quantities to achieve better low-frequency performance. For example, the quantity ratio between the speaker 012 and the low-frequency passive diaphragm 013 can be 1:2, or the quantity ratio between the speaker 012 and the low-frequency passive diaphragm 013 can be 1:1, or the quantity ratio between the speaker 012 and the low-frequency passive diaphragm 013 can be 2:1. In a specific example, as shown in FIG. 1, two speakers 011 and two low-frequency passive diaphragms 013 can be set in the sound chamber 011; In another specific example, as shown in FIG. 2, four speakers 011 and two low-frequency passive diaphragms 013 can be set in the sound chamber 011.

In the embodiments, the speaker 012 and the low-frequency passive diaphragm 013 can be symmetrically arranged at both ends of the neck hanging portion, which can make the setting positions of speaker 012 and low-frequency passive diaphragm 013 closer to the user's ears and provide better sound effects for the user.

In order to achieve better low-frequency effect, in a case that there are multiple numbers of speaker 012 and low-frequency passive diaphragm 013, the speakers 012 and the low-frequency passive diaphragms 013 can be set at intervals. In a specific example, as shown in FIG. 2, at the end of the neck hanging portion, the speakers 012 can be set on both sides of the low-frequency passive diaphragm 013. Of course, in the case that the quantity ratio between the speaker 012 and the low-frequency passive diaphragm 013 can be 1:2, the low-frequency passive diaphragms 013 can also be set on both sides of the speaker 012 at the end of the neck hanging portion.

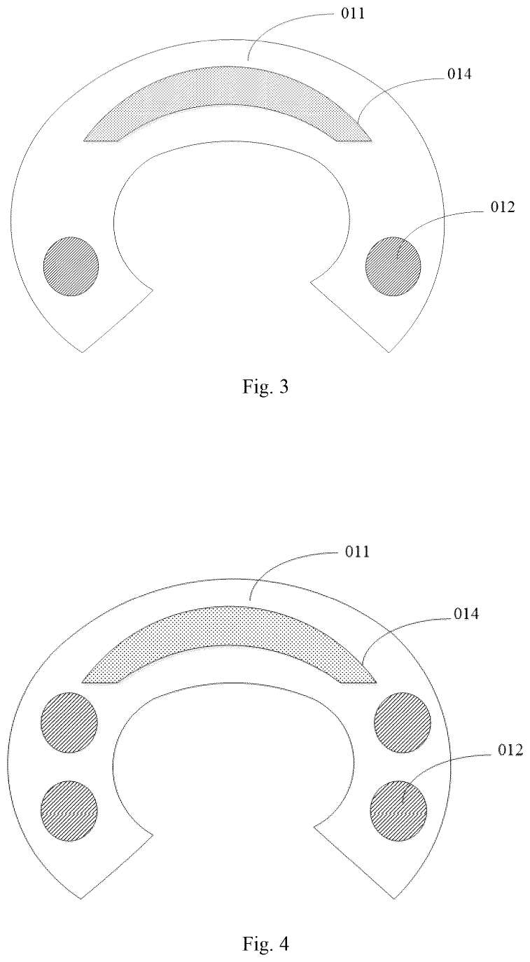

In some embodiments, as shown in FIG. 3 and FIG. 4, the audio device further includes at least one audio waveguide tube 014 located within the sound chamber 011. The low-frequency effect of the audio device can be improved by using the audio waveguide tube 014. In the embodiments, the speaker 012 and the audio waveguide tube 014 can be matched in different quantities to achieve better low-frequency performance. For example, the quantity ratio between the speaker 012 and the audio waveguide tube 014 can be 4:1, or the quantity ratio between the speaker 012 and the audio waveguide tube 014 can be 1:1, or the quantity ratio between the speaker 012 and the audio waveguide tube 014 can be 2:1. In a specific example, as shown in FIG. 3, two speakers 011 and an audio waveguide tube 014 can be set in the sound chamber 011. In another specific example, as shown in FIG. 4, four speakers 011 and an audio waveguide tube 014 can be set in the sound chamber 011.

In the embodiments, the speaker 012 and the audio waveguide tube 014 can be symmetrically arranged at both ends of the neck hanging portion, which can make the setting positions of speaker 012 and audio waveguide tube 014 closer to the user's ears and provide better sound effects for the user.

In order to achieve better low-frequency effect, in a case that there are multiple numbers of speaker 012 and audio waveguide tube 014, the speakers 012 and the audio waveguide tubes 014 can be set at intervals.

In a specific example, as shown in FIG. 3, there are two speakers 012 installed at the ends of the neck hanging portion, and the audio waveguide tube 014 is located between the two speakers 012. Alternatively, as shown in FIG. 4, there are two speakers 012 installed at each end of the neck hanging portion, and the audio waveguide tube 014 is located between the four speakers 012.

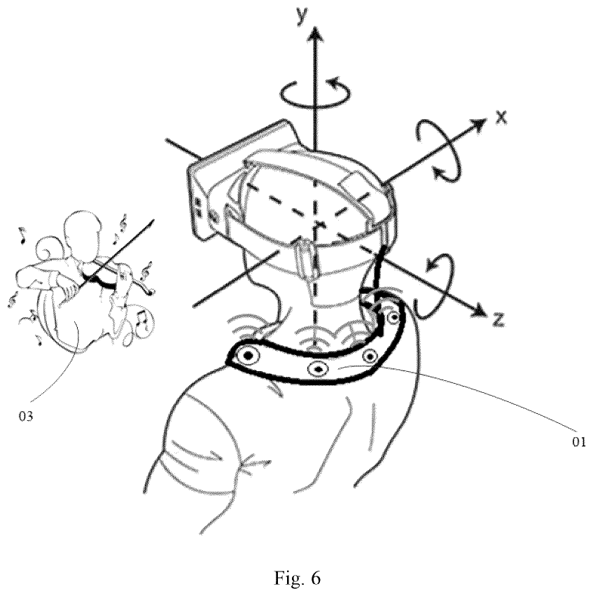

The audio device of the embodiments can be used as an independent audio device, as shown in FIG. 5 and FIG. 6. The audio device 01 of the embodiments can further be applied to VR devices, where 02 is a head-mounted display of the VR device and 03 is a virtual audio source. In related technologies, when a user uses a VR device and the user's behavior changes, the direction of the sound source in virtual reality has already changed for the user. However, the direction of the sound source played in the audio playback device worn by the user (such as headphones) has not changed accordingly, which can affect the immersion created by the virtual screen and reduce the user experience. In the embodiments, the audio device can process audio data in real-time, ensuring that the position of the virtual audio source played by the audio device changes synchronously with the user's behavior, creating a sense of spatial immersion and improving the user experience.

When the audio device of the embodiments is applied to a VR device, the audio device further includes:
a positioning unit, configured to locate a relative position relationship between the speaker and a target part, the target part includes the head and/or ears;

The computing unit is specifically configured to obtain a first position of the virtual audio source in a space coordinate system of the VR device; obtain a second position of the target part in the space coordinate system, and determine a third position of the speaker in the space coordinate system based on the relative position relationship between the speaker and the target part; generate the target sound signal based on the target HRTF at the first position, the HRTF at the third position, and the audio data.

For example, the coordinate of virtual sound source B in the space coordinate system of the VR device is P_{B} (r_{B}, θ_{B}, φ_{B}), r_{B} is a distance between the position of virtual sound source B and the origin of the space coordinate system, θ_{B} is a azimuth angle, φ_{B} is a pitch angle, the virtual sound source B emits sound S_{B}, and the sound signal heard by the human ear is E_{B}=S_{B}*HRTF (r_{B}, θ_{B}, φ_{B}); The coordinate of speaker A in the space coordinate system of the VR device is P_{A} (r_{A}, θ_{A}, φ_{A}), where r_{A} is a distance between the position of speaker A and the origin of the space coordinate system, θ_{A} is a azimuth angle, φ_{A} is a pitch angle, the speaker A emits sound S_{A}, and the sound signal heard by the human ear is E_{A}=S_{A}*HRTF (r_{A}, θ_{A}, φ_{A}). In order for speaker A to simulate the pronunciation of virtual sound source B, it is necessary to make E_{A}=E_{B}, then:

$${S}_{A} = {S}_{B} * HRTF ( {r}_{B} , {θ}_{B} , {φ}_{B} ) / HRTF ( {r}_{A} , {θ}_{A} , {φ}_{A} ) .$$

Therefore, based on the audio data of the virtual audio source, the HRTF (r_{B}, θ_{B}, φ_{B}) at the position of virtual audio source B and the HRTF (r_{A}, θ_{A}, φ_{A}) at the position of speaker A, the speaker A can simulate the virtual sound source B to produce sound, creating a sense of spatial immersion.

In the embodiments, there is no limitation on the method of obtaining HRTFs, and HRTFs at different positions can be obtained by searching a preset HRTF table; Alternatively, HRTFs at different positions can be obtained through software simulation; Alternatively, HRTFs at different positions can be obtained through actual testing.

In the embodiments, the first position of the virtual audio source in the space coordinate system of the VR device can be determined based on the obtained audio data; when users wear a head-mounted display, the second position of the target part in the space coordinate system can be determined based on the position of the head-mounted display in the space coordinate system of the VR device (usually the coordinate origin or a known coordinate point) and a relative position relationship between the head-mounted display and the target part (the target part can be the ears or head); the relative position relationship between the speaker and the target part can be determined based on the positioning unit, and the third position of the speaker in the space coordinate system can be determined based on the second position and the relative position relationship between the speaker and the target part.

In some embodiments, the positioning unit may include a transmitting and receiving unit, which determines a relative position relationship between the head-mounted display and the speaker using methods such as ultrasound, UWB (non-sinusoidal narrow pulse), photoelectric positioning, electromagnetic positioning, etc, and determines the relative position relationship between the speaker and the target part based on the relative position relationship between the head-mounted display and the speaker. Specifically, the transmitting and receiving unit includes a transmitting unit located on the head-mounted display of the VR device and a receiving unit located on the neck hanging portion. The transmitting unit is configured to transmit a target signal, and the receiving unit is configured to determine the relative position relationship between the head-mounted display and the speaker based on the received signal, and determine the relative position relationship between the speaker and the target part based on the relative position relationship between the head-mounted display and the speaker. The target signal includes at least one of the following: non-sinusoidal narrow pulse, ultrasound, optical signal, or electromagnetic wave.

In the embodiments, the transmitting and receiving unit can locate the position of the neck hanging portion relative to the head-mounted display. Since the relative position of the user's target part to the head-mounted display is basically fixed, and the relative position of the neck hanging portion to the speaker is basically fixed, the relative position between the user's target part and the speaker can be calculated. In the embodiments, during positioning, the receiving unit needs to be fixed on the neck hanging portion and cannot move or shake.

Of course, in the embodiments, the transmitting unit can also be set at the neck hanging portion, and the receiving unit can be set at the head-mounted display of the VR device.

In some embodiments, the positioning unit may include an image processing unit set at the neck hanging portion. The image processing unit can obtain an image of the target part and determine the relative position relationship between the speaker and the target part based on the image.

In the embodiments, the image processing unit can include monocular cameras, binocular cameras, depth cameras, etc. When the audio device can obtain an image of the user's target part, the image processing unit obtains the image of the user's target part, and through coordinate system conversion, locates the relative position between the speaker and the target part. For example, when the target part is the ears, the human ear in the image can be segmented through image processing, and the position of ear canal can be obtained. Through coordinate system conversion, the position of each speaker relative to the human ear, Ploudspeaker_j, can be located.

In the embodiments, during positioning, the image processing unit needs to be fixed on the neck hanging portion and cannot move or shake.

In some embodiments, the positioning unit may include an inertial sensor IMU set at the neck hanging portion, configured to record relative rotation and displacement between the head-mounted display of the VR device and the neck hanging portion, determine the relative position between the head-mounted display and the speaker based on the recorded relative rotation and displacement, and determine the relative position relationship between the speaker and the target part based on the relative position between the head-mounted display and the speaker.

The inertial sensor IMU can be combined with other absolute positioning methods to obtain the relative position between the target part and the speaker. For example, after using the image processing unit to locate the relative position between the target part and the speaker, if the user rotates their head so that the image processing unit cannot obtain the human ear image, the relative rotation and displacement between the head-mounted display and the neck hanging portion recorded by the inertial sensor IMU can be configured to determine the relative position of the human ear relative to each speaker. In the embodiments, during positioning, the inertial sensor needs to be fixed on the neck hanging portion and cannot move or shake.

In the embodiments, the positioning unit may only include one of the transmitting and receiving unit, image processing unit, or inertial sensor, and may also include multiple combinations of the transmitting and receiving unit, image processing unit, and inertial sensor. When the positioning unit adopts multiple combinations of the transmitting and receiving unit, image processing unit, and inertial sensor, the positioning accuracy can be improved.

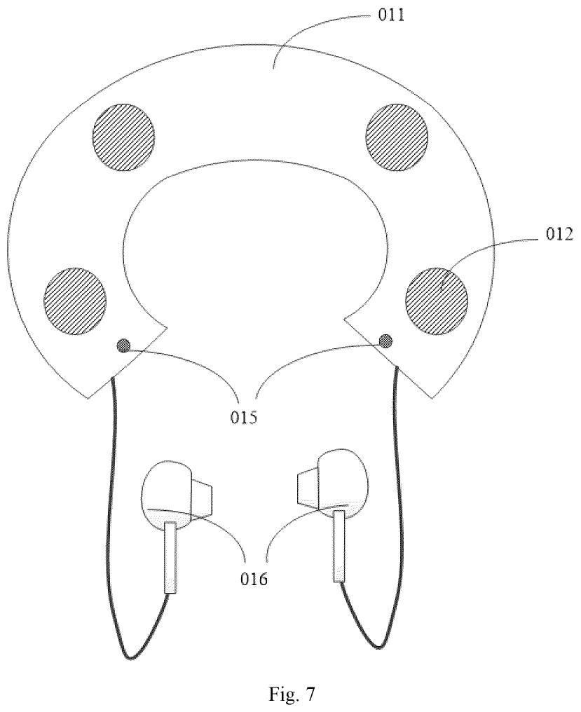

In some embodiments, as shown in FIG. 7, the audio device further includes:
an external interface, configured to connect to wired earphones 016. When the audio device is connected to wired earphones 016, only the target HRTF at the position of virtual sound source B needs to be obtained, denoted as HRTFi. The audio data can be convolved using HRTFi at the position of virtual sound source B to achieve spatial audio.

In some embodiments, as shown in FIG. 7, the audio device further includes:
a microphone 015 set at the neck hanging portion, which can also be configured to achieve voice input function.

In the embodiments, the sound signal emitted by the speaker includes a right channel signal and a left channel signal. Before outputting the target sound signal to the speaker, a crosstalk signal generated by the right channel signal can be eliminated from the left channel signal, and a crosstalk signal generated by the left channel signal can be eliminated from the right channel signal, which can prevent the sound of the left and right ears from interfering with each other and improve the user's auditory experience.

It is worth noting that the above-mentioned neck hanging portion in the embodiments can also be a neck pillow portion.

The above solutions are introduced using a VR device as an example. Similarly, the audio device of the embodiments can also be applied to AR devices.

The embodiments of the present disclosure also provide a VR device, including a head-mounted display and an audio device as described above.

In related art, when a user uses a VR device and the user's behavior changes, the direction of the sound source in virtual reality has already changed for the user. However, the direction of the sound source played in the audio playback device worn by the user (such as headphones) has not changed accordingly, which can affect the immersion created by the virtual screen and reduce the user experience. In the embodiments, the audio device can process audio data in real-time, ensuring that the position of the virtual audio source played by the audio device changes synchronously with the user's behavior, creating a sense of spatial immersion and improving the user experience.

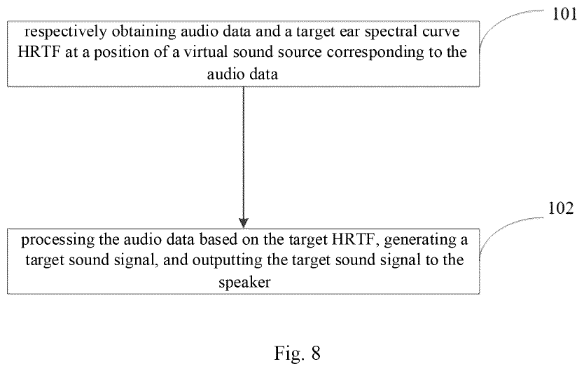

The embodiments of the present disclosure further provide a working method of audio device applied to the audio device as described above, as shown in FIG. 8, where the working method includes:

Step 101: respectively obtain audio data and a target ear spectral curve HRTF at a position of a virtual sound source corresponding to the audio data;

Step 102: process the audio data based on the target HRTF, generate a target sound signal, and output the target sound signal to the speaker.

In the embodiments, obtain the target HRTF at the position of the virtual sound source corresponding to the audio data, process the audio data based on the target HRTF, generate the target sound signal, and control the speaker to produce sound based on the target sound signal, which can achieve simulated three-dimensional sound production in space and create a sense of spatial immersion.

HRTF is an abbreviation for Head Related Transfer Function, also known as Ear Spectral Curve. HRTF is a mathematical function configured to measure and evaluate the transmission of sound in the human ear. It can measure spatial characteristics generated when sound is transmitted through the human eardrum, and can simulate three-dimensional sound production in space through HRTF.

In related art, whether it is an in-ear headphone or a headset, long-term wear can easily affect the user's listening ability. Wearing an in-ear headphone too frequently can easily lead to problems such as ear canal inflammation, while wearing a headset can easily cause stuffiness and sweating. In the embodiments, the audio device can be a neck hanging audio device, as shown in FIG. 5. The audio device 01 can be worn on the user's neck, which can avoid the harm of in-ear headphones or headsets.

In some embodiments, the sound signal includes a right channel signal and a left channel signal, and the method further includes:
eliminate a crosstalk signal generated by the right channel signal from the left channel signal, and eliminate a crosstalk signal generated by the left channel signal from the right channel signal, which can prevent the sound of the left and right ears from interfering with each other and improve the user's auditory experience.

In some embodiments, the working method further includes:
locate a relative position relationship between the speaker and a target part, the target part includes the head and/or ears;

The processing the audio data based on the target HRTF and generating a target sound signal includes:
obtain a first position of the virtual audio source in a space coordinate system of the VR device; obtain a second position of the target part in the space coordinate system, and determine a third position of the speaker in the space coordinate system based on the relative position relationship between the speaker and the target part; generate the target sound signal based on the target HRTF at the first position, the HRTF at the third position, and the audio data.

For example, the coordinate of virtual sound source B in the space coordinate system of the VR device is P_{B} (r_{B}, θ_{B}, φ_{B}), r_{B} is a distance between the position of virtual sound source B and the origin of the space coordinate system, θ_{B} is a azimuth angle, φ_{B} is a pitch angle, the virtual sound source B emits sound S_{B}, and the sound signal heard by the human ear is E_{B}=S_{B}*HRTF (r_{B}, θ_{B}, φ_{B}); The coordinate of speaker A in the space coordinate system of the VR device is P_{A} (r_{A}, θ_{A}, φ_{A}), where r_{A} is a distance between the position of speaker A and the origin of the space coordinate system, θ_{A} is a azimuth angle, φ_{A} is a pitch angle, the speaker A emits sound S_{A}, and the sound signal heard by the human ear is E_{A}=S_{A}*HRTF (r_{A}, θ_{A}, φ_{A}). In order for speaker A to simulate the pronunciation of virtual sound source B, it is necessary to make E_{A}=E_{B}, then:

$${S}_{A} = {S}_{B} * HRTF ( {r}_{B} , {θ}_{B} , {φ}_{B} ) / HRTF ( {r}_{A} , {θ}_{A} , {φ}_{A} ) .$$

Therefore, based on the audio data of the virtual audio source, the HRTF (r_{B}, θ_{B}, φ_{B}) at the position of virtual audio source B and the HRTF (r_{A}, θ_{A}, φ_{A}) at the position of speaker A, the speaker A can simulate the virtual sound source B to produce sound, creating a sense of spatial immersion.

In the embodiments, there is no limitation on the method of obtaining HRTFs, and HRTFs at different positions can be obtained by searching a preset HRTF table; Alternatively, HRTFs at different positions can be obtained through software simulation; Alternatively, HRTFs at different positions can be obtained through actual testing.

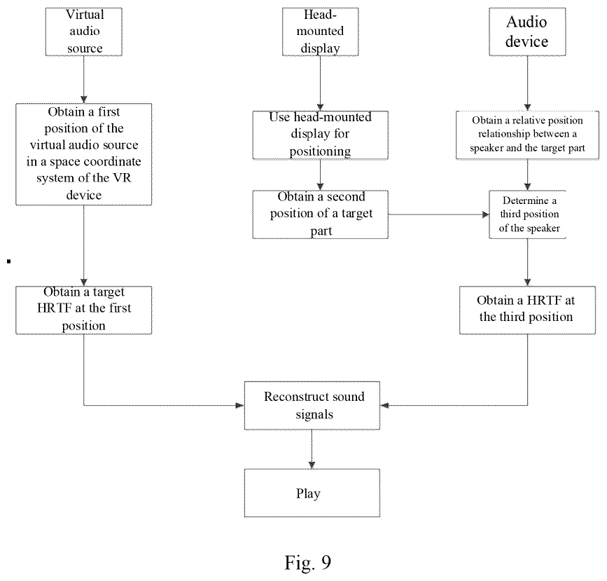

In the embodiment, as shown in FIG. 9, the first position of the virtual audio source in the space coordinate system of the VR device can be determined based on the obtained audio data, and then the target HRTF at the first position can be obtained; When users wear a head-mounted display, the second position of the target part in the space coordinate system can be determined based on the position of the head-mounted display in the space coordinate system of the VR device (usually the coordinate origin or a known coordinate point) and a relative position relationship between the head-mounted display and the target part (the target part can be the ears or head); the relative position relationship between the speaker and the target part can be obtained based on a positioning unit, and the third position of the speaker in the space coordinate system can be determined based on the second position and the relative position relationship between the speaker and the target part, thereby obtaining the HRTF at the third position. Reconstruct the audio data based on the target HRTF at the first position and the HRTF at the third position to obtain the sound signal, and control the speaker to play the sound signal to achieve a spatial sound field.

In some embodiments, the positioning unit may include a transmitting and receiving unit, and the locating a relative position relationship between the speaker and a target part includes:
use a transmitting unit to transmit a target signal, use a receiving unit to determine the relative position relationship between the head-mounted display and the speaker based on the received signal, and determine the relative position relationship between the speaker and the target part based on the relative position between the head-mounted display and the speaker. The target signal includes at least one of the following: non-sinusoidal narrow pulse, ultrasound, optical signal, or electromagnetic wave.

Specifically, the transmitting and receiving unit includes a transmitting unit located on the head-mounted display of the VR device and a receiving unit located on the neck hanging portion. The transmitting unit is configured to transmit a target signal, and the receiving unit is configured to determine the relative position relationship between the head-mounted display and the speaker based on the received signal, and determine the relative position relationship between the speaker and the target part based on the relative position between the head-mounted display and the speaker. The target signal includes at least one of the following: non-sinusoidal narrow pulse, ultrasound, optical signal, or electromagnetic wave.

In the embodiments, the transmitting and receiving unit can locate the position of the neck hanging portion relative to the head-mounted display. Since the relative position of the user's target part to the head-mounted display is basically fixed, and the relative position of the neck hanging portion to the speaker is basically fixed, the relative position between the user's target part and the speaker can be calculated. In the embodiments, during positioning, the receiving unit needs to be fixed on the neck hanging portion and cannot move or shake.

Of course, in the embodiments, the transmitting unit can also be set at the neck hanging portion, and the receiving unit can be set at the head-mounted display of the VR device.

In some embodiments, the positioning unit may include an image processing unit, and the locating a relative position relationship between the speaker and a target part includes:
use the image processing unit to obtain an image of the target part, and determine the relative position relationship between the speaker and the target part based on the image.

In the embodiments, the image processing unit can include monocular cameras, binocular cameras, depth cameras, etc. When the audio device can obtain an image of the user's target part, the image processing unit obtains the image of the user's target part, and through coordinate system conversion, locates the relative position between the speaker and the target part. For example, when the target part is the ears, the human ear in the image can be segmented through image processing, and the position of ear canal can be obtained. Through coordinate system conversion, the position of each speaker relative to the human ear, Ploudspeaker_j, can be located.

In the embodiments, during positioning, the image processing unit needs to be fixed on the neck hanging portion and cannot move or shake.

In some embodiments, the positioning unit may include an inertial sensor IMU, and the locating a relative position relationship between the speaker and a target part includes:
use the inertial sensor IMU to record relative rotation and displacement between the head-mounted display of the VR device and the neck hanging portion, determine the relative position between the head-mounted display and the speaker based on the recorded relative rotation and displacement, and determine the relative position relationship between the speaker and the target part based on the relative position between the head-mounted display and the speaker.

The inertial sensor IMU can be combined with other absolute positioning methods to obtain the relative position between the target part and the speaker. For example, after using the image processing unit to locate the relative position between the target part and the speaker, if the user rotates their head so that the image processing unit cannot obtain the human ear image, the relative rotation and displacement between the head-mounted display and the neck hanging portion recorded by the inertial sensor IMU can be configured to determine the relative position of the human ear relative to each speaker. In the embodiments, during positioning, the inertial sensor needs to be fixed on the neck hanging portion and cannot move or shake.

In the embodiments, the positioning unit may only include one of the transmitting and receiving unit, image processing unit, or inertial sensor, and may also include multiple combinations of the transmitting and receiving unit, image processing unit, and inertial sensor. When the positioning unit adopts multiple combinations of the transmitting and receiving unit, image processing unit, and inertial sensor, the positioning accuracy can be improved.

It should be noted that the various embodiments in the present description are described in a progressive manner, and the various embodiments may refer to each other for the same or similar parts, and each embodiment focuses on differences from other embodiments. Especially, for the method embodiment, since it is basically similar to the product embodiment, the description is relatively simple, and the relevant parts can be referred to the description of the product embodiment.

Unless otherwise defined, technical terms or scientific terms configured in the present disclosure shall have the common meanings understood by those with ordinary skills in the field to which the present disclosure belongs. “First”, “second” and similar words configured in the present disclosure do not indicate any order, quantity, or importance, but are only configured to distinguish different components. “Include” or “comprise” and other similar words mean that the element or item before the word encompasses the element or item and their equivalents listed after the word, but does not exclude other elements or items. Similar words such as “coupled” or “connected” are not limited to physical or mechanical connections, but may include electrical connections, whether direct or indirect. “Up”, “down”, “left”, “right”, etc. are only configured to indicate a relative position relationship. When an absolute position of a described object changes, the relative position relationship may also change accordingly.

It should be appreciated that, in the case that such an element as layer, film, region or substrate is arranged “on” or “under” another element, it may be directly arranged “on” or “under” the other element, or an intermediate element may be arranged therebetween.

In descriptions of the implementation modes, the specific features, structures, materials, or characteristics described may be combined in any suitable manner in any one or more embodiments or examples.

The foregoing are only specific embodiments of the present disclosure, but the protection scope of the present disclosure is not limited thereto. In the technical scope disclosed by the present disclosure, changes or substitutions easily thought by any skilled in the art are all covered in the protection scope of the present disclosure. Therefore, the protection scope of the present disclosure should be the protection scope of the claims.

What is claimed is:

1. An audio device, comprising:
a sound chamber;
at least one speaker located within the sound chamber;
an acquisition unit, configured to respectively obtain audio data and a target ear spectral curve HRTF at a position of a virtual sound source corresponding to the audio data;
a computing unit, configured to process the audio data based on the target HRTF, generate a target sound signal, and output the target sound signal to the speaker.

2. The audio device according to claim 1, wherein the audio device is a neck hanging audio device, the sound chamber is located within the neck hanging portion of the neck hanging audio device.

3. The audio device according to claim 2, further comprising:
a power supply located within the neck hanging portion;
the speaker is connected to the power supply through wired means.

4. The audio device according to claim 2, further comprising:
at least one low-frequency passive diaphragm and/or audio waveguide tube located within the sound chamber.

5. The audio device according to claim 4, wherein
the low-frequency passive diaphragm and the speaker are set at intervals; and/or,
the audio waveguide tube and the speaker are set at intervals.

6. The audio device according to claim 2, wherein the audio device is applied to a VR device, and the audio device further comprises:
a positioning unit, configured to locate a relative position relationship between the speaker and a target part, the target part comprises head and/or ears;
the computing unit is specifically configured to obtain a first position of a virtual audio source in a space coordinate system of the VR device; obtain a second position of the target part in the space coordinate system, and determine a third position of the speaker in the space coordinate system based on the relative position relationship between the speaker and the target part; generate the target sound signal based on the target HRTF at the first position, the HRTF at the third position, and the audio data.

7. The audio device according to claim 6, wherein the positioning unit comprises at least one of the following:
a transmitting and receiving unit, comprising a transmitting unit located on a head-mounted display of the VR device and a receiving unit located on the neck hanging portion, the transmitting unit is configured to transmit a target signal, and the receiving unit is configured to determine a relative position relationship between the head-mounted display and the speaker based on the received signal, and determine the relative position relationship between the speaker and the target part based on the relative position relationship between the head-mounted display and the speaker, the target signal comprises at least one of the following: non-sinusoidal narrow pulse, ultrasound, optical signal, or electromagnetic wave;
an image processing unit set at the neck hanging portion, configured to obtain an image of the target part and determine the relative position relationship between the speaker and the target part based on the image;
an inertial sensor IMU set at the neck hanging portion, configured to record relative rotation and displacement between the head-mounted display of the VR device and the neck hanging portion, determine the relative position between the head-mounted display and the speaker based on the recorded relative rotation and displacement, and determine the relative position relationship between the speaker and the target part based on the relative position between the head-mounted display and the speaker.

8. The audio device according to claim 2, further comprising:
an external interface, configured to connect to wired earphones.

9. The audio device according to claim 2, further comprising:
a microphone set at the neck hanging portion.

10. A VR device comprising a head-mounted display and an audio device according to claim 1.

11. A working method of audio device, applied to an audio device according to claim 1, comprising:
respectively obtaining audio data and a target ear spectral curve HRTF at a position of a virtual sound source corresponding to the audio data;
processing the audio data based on the target HRTF, generating a target sound signal, and outputting the target sound signal to the speaker.

12. The working method of audio device according to claim 11, wherein the sound signal comprises a right channel signal and a left channel signal, before outputting the target sound signal to the speaker, the method further comprises:
eliminating a crosstalk signal generated by the right channel signal from the left channel signal, and eliminating a crosstalk signal generated by the left channel signal from the right channel signal.

13. The working method of audio device according to claim 11, wherein
the audio device is a neck hanging audio device, the sound chamber is located within the neck hanging portion of the neck hanging audio device;
wherein the audio device is applied to a VR device, and the audio device further comprises:
a positioning unit, configured to locate a relative position relationship between the speaker and a target part, the target part comprises head and/or ears;
the computing unit is specifically configured to obtain a first position of a virtual audio source in a space coordinate system of the VR device; obtain a second position of the target part in the space coordinate system, and determine a third position of the speaker in the space coordinate system based on the relative position relationship between the speaker and the target part; generate the target sound signal based on the target HRTF at the first position, the HRTF at the third position, and the audio data;
the working method further comprises:
locating a relative position relationship between the speaker and a target part, the target part comprises head and/or ears;
the processing the audio data based on the target HRTF and generating a target sound signal comprises:
obtaining a first position of a virtual audio source in a space coordinate system of the VR device; obtaining a second position of the target part in the space coordinate system, and determining a third position of the speaker in the space coordinate system based on the relative position relationship between the speaker and the target part; generating the target sound signal based on the target HRTF at the first position, the HRTF at the third position, and the audio data.

14. The working method of audio device according to claim 13,
wherein the positioning unit comprises at least one of the following:
a transmitting and receiving unit, comprising a transmitting unit located on a head-mounted display of the VR device and a receiving unit located on the neck hanging portion, the transmitting unit is configured to transmit a target signal, and the receiving unit is configured to determine a relative position relationship between the head-mounted display and the speaker based on the received signal, and determine the relative position relationship between the speaker and the target part based on the relative position relationship between the head-mounted display and the speaker, the target signal comprises at least one of the following: non-sinusoidal narrow pulse, ultrasound, optical signal, or electromagnetic wave;
an image processing unit set at the neck hanging portion, configured to obtain an image of the target part and determine the relative position relationship between the speaker and the target part based on the image;
an inertial sensor IMU set at the neck hanging portion, configured to record relative rotation and displacement between the head-mounted display of the VR device and the neck hanging portion, determine the relative position between the head-mounted display and the speaker based on the recorded relative rotation and displacement, and determine the relative position relationship between the speaker and the target part based on the relative position between the head-mounted display and the speaker;
wherein the locating a relative position relationship between the speaker and a target part comprises at least one of the following:
using the transmitting unit to transmit a target signal, using the receiving unit to determine the relative position relationship between the head-mounted display and the speaker based on the received signal, and determining the relative position relationship between the speaker and the target part based on the relative position between the head-mounted display and the speaker, the target signal comprises at least one of the following: non-sinusoidal narrow pulse, ultrasound, optical signal, or electromagnetic wave;
using the image processing unit to obtain an image of the target part, and determining the relative position relationship between the speaker and the target part based on the image;
using the inertial sensor IMU to record relative rotation and displacement between the head-mounted display of the VR device and the neck hanging portion, determining the relative position between the head-mounted display and the speaker based on the recorded relative rotation and displacement, and determining the relative position relationship between the speaker and the target part based on the relative position between the head-mounted display and the speaker.
